(19) United States
(12) Patent Application Publication
(10) Pub. No.: US 2026/0221847 A1
(43) Pub. Date: Jul. 30, 2026

(54) MOTOR POSITION SENSOR COMPENSATING ERROR APPARATUS AND METHOD

(71) Applicant: HL MANDO CORPORATION, Gyeonggi-do (KR)

(72) Inventors: Yunjai OH, Gyeonggi-do (KR); Jaesang PARK, Gyeonggi-do (KR)

(21) Appl. No.: 19/388,978

(22) Filed: Nov. 13, 2025

(30) Foreign Application Priority Data
Jan. 24, 2025 (KR) 10-2025-0011721

(51) Int. Cl. H02K 11/21; B62D 5/04; B62D 15/02; G01B 21/22

(52) U.S. Cl. CPC H02K 11/21; B62D 5/046; B62D 15/0235; G01B 21/22

(57) ABSTRACT

A motor position sensor error compensation apparatus includes a controller configured to control a steering motor to move to a first motor position, a sensor configured to detect a second motor position of the steering motor through a motor position sensor, and a one or more processors configured to determine a position error between the first motor position and the second motor position and determine a compensation angle for the second motor position based on the position error.

### CROSS-REFERENCE TO RELATED APPLICATIONS

This application claims the priority of Korean Patent Application No. 10-2025-0011721 filed on Jan. 24, 2025, in the Korean Intellectual Property Office, the disclosure of which is incorporated herein by reference.

### BACKGROUND

### Field

The present embodiments relate to a motor position sensor error compensation apparatus and method.

### Description of the Related Art

In a general electric power steering (EPS) system, more than 90% use a permanent magnet synchronous machine (PMSM). Due to the characteristics of PMSM, it is important to accurately identify the position of a rotor in order to drive the motor accurately and efficiently. To this end, a motor position sensor (MPS) may be used or a sensor-less algorithm may be used to estimate the position of the rotor and perform control.

In the case of the EPS system, fast forward/reverse switching is required, and steering feel and responsiveness are also very important factors, so a control method that includes a motor position sensor is mainly adopted. In particular, in a steer-by-wire (SbW) system, where a position of a rack is directly determined by the motor according to a steering angle of a steering wheel, accurate detection of the rotor position may be even more important for the performance and safety of the system.

In addition, the electric system may generate noise and vibration due to MPS secondary torque ripple generated in the mechanical configuration, which may lead to a degradation in the performance of the system. For example, in the chassis, secondary noise and vibration characteristics may cause the vehicle to boom. This problem may not only negatively affect the user's steering feel, but also potentially reduce the overall driving experience.

Therefore, in order to improve the performance and ensure the reliability of EPS and SbW systems, technology development is required to accurately detect the position of the rotor and minimize noise and vibration caused by torque ripple.

### SUMMARY

From this background, the present disclosure seeks to provide a technology for compensating information detected by a motor position sensor (MPS).

In order to solve the above-mentioned problem, in one aspect, the present disclosure provides a motor position sensor error compensation apparatus including: a controller configured to control a steering motor to move to a first motor position; a motor position sensor configured to detect a second motor position of the steering motor; and one or more processors configured to determine a position error between the controlled first motor position and the detected second motor position and determine a compensation angle for the detected second motor position based on the position error between the controlled first motor position and the detected second motor position.

In another aspect, the present disclosure provides a motor position sensor error compensation method including: controlling a steering motor to move to a first motor position; detecting a second motor position of the steering motor through a motor position sensor; and determining a position error between the controlled first motor position and the detected second motor position and determining a compensation angle for the detected second motor position based on the position error between the controlled first motor position and the detected second motor position.

In another aspect, the present disclosure provides a vehicle control device including: memory configured to store instructions; and at least one processor configured to be operable to execute the instructions to: control a steering motor to move to a first motor position, detect a second motor position of the steering motor through a motor position sensor, determine a position error between the controlled first motor position and the detected second motor position, and determine a compensation angle for the detected second motor position based on the position error between the controlled first motor position and the detected second motor position.

According to the present disclosure, a mounting error of MPS can be compensated.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram briefly explaining a motor position sensor error compensation apparatus according to one embodiment of the present disclosure;

FIG. 2 is a diagram illustrating FFT results of an angle error component by current before compensation according to one embodiment;

FIG. 3A is a diagram illustrating an angle error determined according to a motor position at a current of 10 A according to one embodiment;

FIG. 3B is a diagram illustrating an angle error determined according to a motor position at a current of 30 A according to one embodiment;

FIG. 4 is a diagram illustrating FFT results of each position error component by current after applying a compensation angle according to one embodiment;

FIG. 5A is a diagram illustrating an angle error determined according to the motor position at a current of 10 A according to one embodiment, by distinguishing whether the compensation angle is applied;

FIG. 5B is a diagram illustrating an angle error determined according to the motor position at a current of 30 A according to one embodiment, by distinguishing whether the compensation angle is applied;

FIG. 6 is a diagram illustrating a torque waveform according to one embodiment, by distinguishing whether the compensation angle is applied;

FIG. 7 is a diagram illustrating torque FFT results according to one embodiment, by distinguishing whether the compensation angle is applied;

FIG. 8 is a diagram illustrating a result of applying the compensation angle to a second motor position according to one embodiment;

FIG. 9 is a block diagram of a motor position sensor error compensation apparatus according to another embodiment of the present disclosure;

FIG. 10 is a flowchart explaining a motor position sensor error compensation method according to an embodiment of the present disclosure; and

FIG. 11 is a diagram for explaining Step S1030 according to an embodiment in more detail.

### DETAILED DESCRIPTION OF THE EMBODIMENT

In the following description of examples or embodiments of the present disclosure, reference will be made to the accompanying drawings in which it is illustrated by way of illustration specific examples or embodiments that can be implemented, and in which the same reference numerals and signs can be used to designate the same or like components even when they are illustrated in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements or the like, but is used merely to distinguish the corresponding element from other elements.

When it is mentioned that a first element “is connected or coupled to”, “contacts or overlaps” or the like a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, or the like each other via a fourth element. Here, the second element may be included in at least one of two or more elements that “are connected or coupled to”, “contact or overlap”, or the like each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes or the like are mentioned, it should be considered that numerical values for an elements or features, or corresponding information (for example, level, range, or the like) include a tolerance or error range that may be caused by various factors (for example, process factors, internal or external impact, noise, or the like) even when a relevant description is not specified. Further, the term “may” fully encompass all the meanings of the term “can”.

Hereinafter, the motor position sensor error compensation apparatus of the present disclosure will be described with reference to the attached drawings.

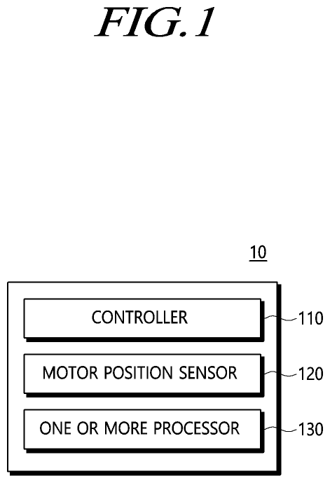

FIG. 1 is a block diagram briefly explaining a motor position sensor error compensation apparatus 10 according to one embodiment of the present disclosure.

Referring to FIG. 1, the motor position sensor error compensation apparatus 10 of the present disclosure may include a controller 110, a motor position sensor 120, and one or more processors 130.

The present disclosure may include the controller 110 that controls a steering motor to move to a first motor position, the motor position sensor 120 that detects a second motor position of the steering motor, and the one or more processors 130 configured to determine a position error between the controlled first motor position and the detected second motor position and determine a compensation angle for the detected second motor position based on the position error between the controlled first motor position and the detected second motor position.

In one embodiment, the motor position sensor error compensation apparatus 10 may be an advance driver assistance system (ADAS) that provides information to assist in driving a host vehicle or assists a driver in controlling the host vehicle. In another embodiment, the motor position sensor error compensation apparatus 10 may be a motor applied to an electromechanical brake (EMB).

The controller 110 may control the steering motor to move to the first motor position. Here, the motor position may mean the position of a rotor included in the steering motor.

In one embodiment, the steering motor may be a motor that provides assist torque to the steering wheel in an electric power steering (EPS) system, and may a motor that provides a reaction torque to the driver in a steer-by-wire (SbW) system or moves a rack linked to a wheel to change a traveling direction of the vehicle. The controller 110 may output a control current according to the purpose to move the steering motor to a specific angle or forcefully align the steering motor.

The motor position sensor 120 may detect the second motor position of the steering motor. The MPS may have an error in the motor position for various reasons. For example, due to the nonlinearity of the sensor sensitivity, the sensitivity of the magnetic sensor used by the MPS may not change linearly depending on the magnetic field strength. The sensitivity may be high in a specific range of magnetic field strengths and low in another range, which may result in a nonlinear output. For another example, in a case where the center of the rotor does not coincide with (is eccentric with) a puck magnet attached to the rotor for rotor position detection, an angular error of a mechanical second component may occur. The angle error causes a mechanical second torque ripple in a case where the motor is driven, and the torque ripple of the second component may cause vibration and noise in a load system, which may deteriorate the performance of the entire system.

Accordingly, compensation is required for the second motor position detected by the MPS, and in the present disclosure, the rotor is forcibly aligned to obtain the first position, which is the actual motor position, and the position error may be determined by comparing the first position with the second motor position.

The one or more processors 130 may determine the position error between the controlled first motor position and the detected second motor position and determine the compensation angle for the detected second motor position based on the position error between the controlled first motor position and the detected second motor position.

In one embodiment, the one or more processors 130 may add a signal opposite to the position error to the compensation angle. Specifically, the one or more processors 130 may perform Fast Fourier Transform (FFT) on the position error and add a phase, which is the result of the FFT, to the compensation angle. For example, in a case where the size of the position error is determined as 0.71 and the phase as 271 degrees, the compensation angle is expressed as a size of 0.71 and a phase of 91 degrees (an error inverse signal), and this compensation angle may be expressed as in the following Mathematical Expression 1.

$${θ}_{comp} = 0.71 \cdot sin ( 2 \cdot {θ}_{MPS} + 91 \cdot \frac{π}{180} ) \qquad [ Mathematical Expression 1 ]$$

When the one or more processors 130 determines the position error, the one or more processors 130 may add the reference angle to the first motor position and obtain the position error between the plurality of calculated first motor positions and the plurality of calculated second motor positions. For example, the one or more processors 130 may start from 0 deg which the first motor position and determine the position error between the first motor position and the second motor position. Then, the one or more processors 130 may add 1 deg which is the reference angle to the first motor position and determine the position error between the first motor position moved by 1 deg by the controller 110 and the second motor position, which is the motor position detection result of the steering motor moved to the first motor position. In this case, the reference angle may be any angle equal to or less than 22.5 deg, not 1 deg, depending on the system. As described above, the one or more processors 130 may determine and store the position error between the plurality of first motor positions and the plurality of second motor positions.

By utilizing multiple position errors, the one or more processors 130 may generate a compensation table including a plurality of compensation angles according to the first motor position. Specifically, the one or more processors 130 may perform FFT on the plurality of position errors to determine the compensation angles, and generate a table storing the a plurality of compensation angles to be applied to the first motor position.

The one or more processors 130 may determine the compensation angle for the detected second motor position by using an interpolation technique when the compensation angle corresponding to the detected second motor position is not included in the compensation table. The one or more processors 130 may use any one of linear interpolation, polynomial interpolation, spline interpolation, and nearest neighbor interpolation.

For example, the one or more processors 130 may determine the compensation angle that is not in the compensation table by utilizing the linear interpolation technique, and utilize the following Mathematical Expression 2.

$$y = {y}_{1} + \frac{( x - {x}_{1} )}{( {x}_{2} - {x}_{1} )} \times ( {y}_{2} - {y}_{1} ) \qquad [ Mathematical Expression 2 ]$$

Here, x1 and x2 are adjacent to a second motor position x where no compensation angle exists and a second motor position where a compensation angle exists, and y1 and y2 may represent the compensation angles of x1 and x2, respectively.

That is, in a case where there are two points (x1,y1) and (x2,y2), the one or more processors 130 may determine the y value corresponding to x between x1 and x2.

Additionally, the one or more processors 130 may determine an average value of compensation angles determined from each of the plurality of position errors and apply the average value to the second motor position.

Accordingly, the present disclosure may quickly apply the compensation angle to the second motor position detected by the motor position 120.

In addition, the present disclosure may reduce torque ripple by securing linearity between the actual motor position and the detected motor position by determining and applying the compensation angle at the second motor position.

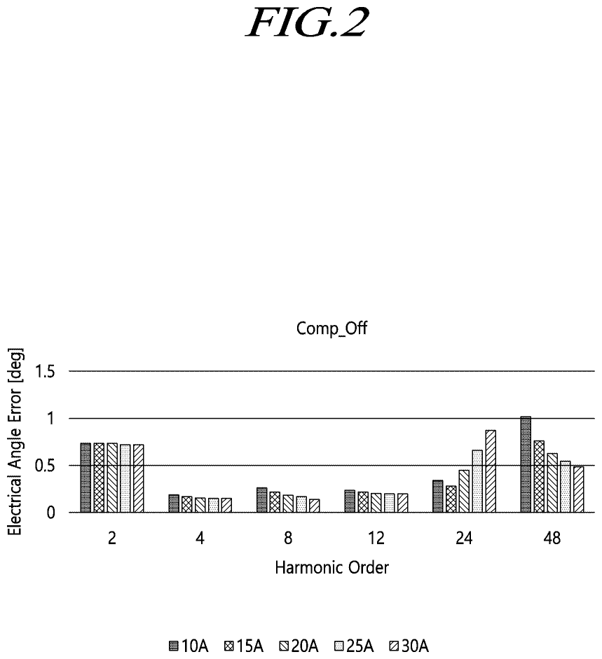

FIG. 2 is a diagram illustrating the FFT results of an angle error component by current before compensation according to one embodiment.

Referring to FIG. 2, it may be confirmed that in the second harmonic, the angle error component is not affected by the current size. Moreover, it may be confirmed that in the 24th and 48th harmonics, the current size is affected by the angle error, which indicates that cogging torque may exist. It may be confirmed that the angle error occurring in the 24th and 48th harmonics is a component due to the position error between the actual motor position and the MPS detected motor position.

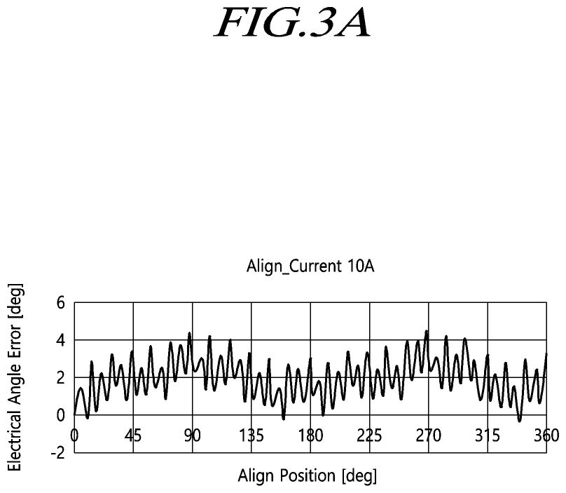

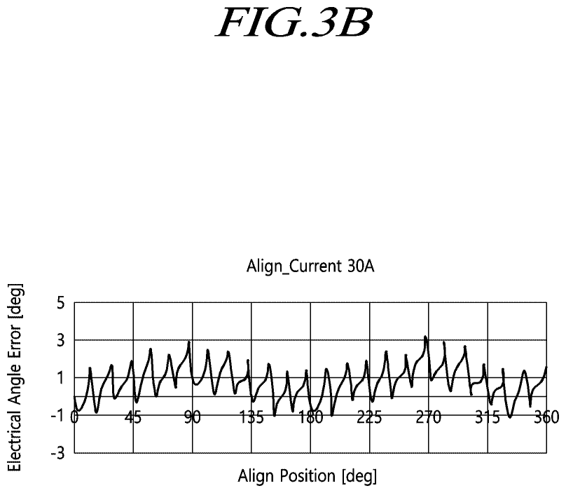

FIG. 3A is a diagram illustrating an angle error determined according to the motor position at a current of 10 A according to one embodiment, and FIG. 3B is a diagram illustrating an angle error determined according to the motor position at a current of 30 A according to one embodiment.

Referring to FIGS. 3A and 3B, FIGS. 3A and 3B illustrate how the angle error of the motor changes under specific current conditions. FIGS. 3A and 3B illustrate that the angle error illustrates a repeating pattern from 0 to 360 degrees, and a periodic wave shape appears.

Specifically, in the repetitive pattern, the angle error is illustrated to fluctuate periodically as the angle of the steering motor increases, which confirms that mechanical or electrical disharmony occurs according to the rotational position of the motor. In addition, in the amplitude change, the width of the angle error increases or decreases at a specific angle of the motor, which confirms the possibility of MPS error or system asymmetry at a specific angle. In addition, since the periodic variability is distinct in the repetitive pattern, the possibility of analyzing the frequency component using Fast Fourier Transform (FFT) may be confirmed. In addition, it may be confirmed that the angle error occurs regardless of the current size.

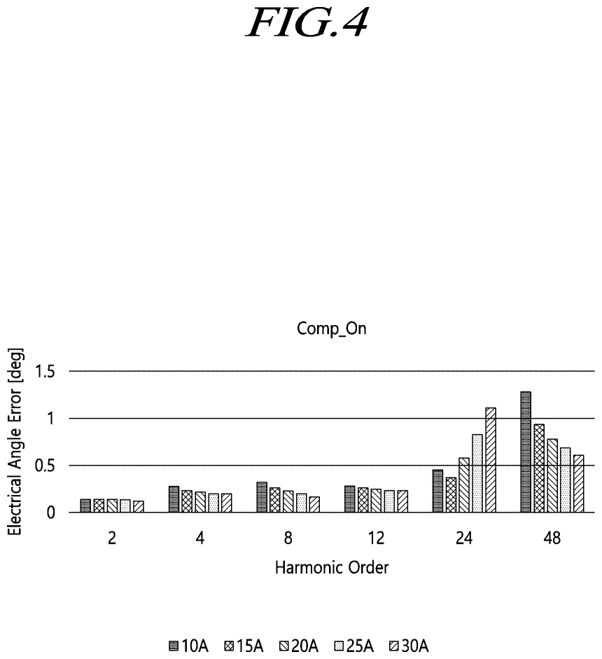

FIG. 4 is a diagram illustrating the FFT results of each position error component by current after applying the compensation angle according to one embodiment.

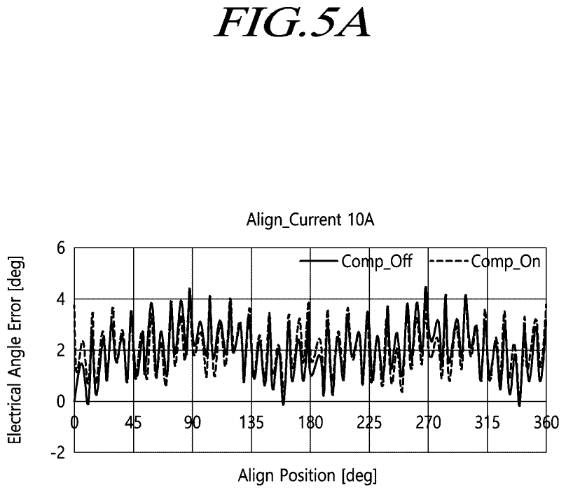

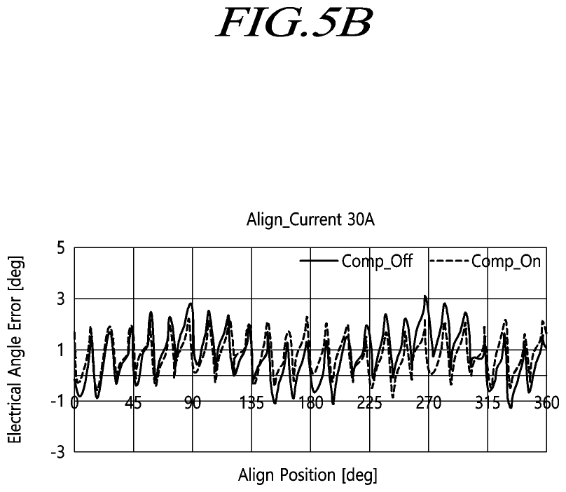

FIG. 5A is a diagram illustrating an angle error determined according to the motor position at a current of 10 A according to one embodiment, by distinguishing whether the compensation angle is applied, and FIG. 5B is a diagram illustrating an angle error determined according to the motor position at a current of 30 A according to one embodiment, by distinguishing whether the compensation angle is applied.

Referring to FIG. 4, in a case where the compensation angle is applied to the second motor position, it may be confirmed that the size of the mechanical second-order angle error component in the second harmonic is reduced (0.71 deg>0.10 deg, 86% reduction). In addition, it may be confirmed that the size reduction of the angle error component is reduced at all currents (10A, 15A, 20 A, 25 A, and 30 A).

Referring to FIG. 5A and FIG. 5B, it may be confirmed that the angle error before applying the compensation angle (Comp_Off) is larger than the angle error after applying the compensation angle (Comp_On), and that the amplitude is not constant and periodic fluctuations occur. In addition, it may be confirmed that the error amplitude is smaller and the fluctuations are reduced after applying the compensation angle (Comp_On). Therefore, it may be confirmed that the steering motor may illustrate more uniform performance after applying the compensation angle.

In addition, in FIG. 5A and FIG. 5B, it may be confirmed that after applying the compensation angle (Comp_On), the angle error is reduced overall regardless of the current.

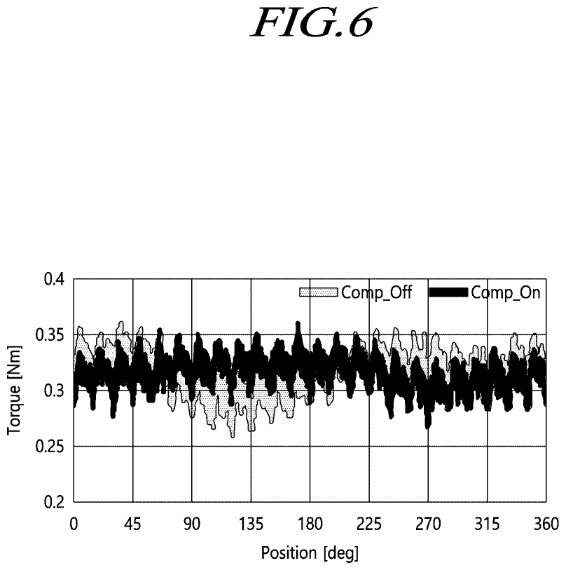

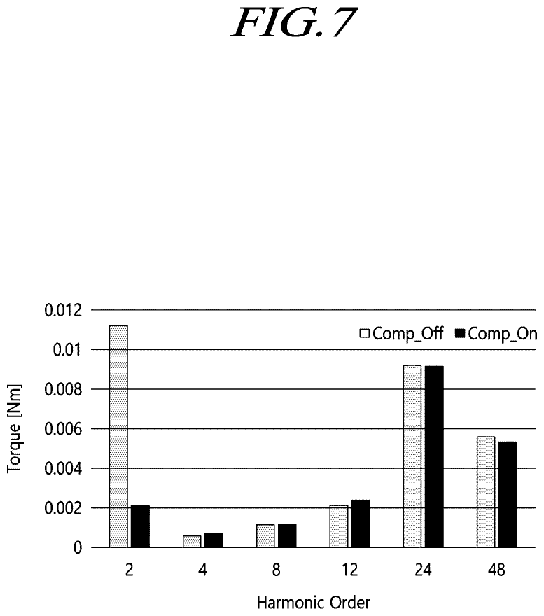

FIG. 6 is a diagram illustrating a torque waveform according to one embodiment, by distinguishing whether the compensation angle is applied, and FIG. 7 is a diagram illustrating a torque FFT result according to one embodiment, by distinguishing whether the compensation angle is applied.

Referring to FIGS. 6 and 7, it may be confirmed that the size of the second harmonic torque ripple is reduced by 81% from 11.3 mNm to 2.2 mNm in a case where a d-axis current applied to the steering motor is 30 A and a q-axis current is 15 A. That is, it may be confirmed that the torque waveform according to the motor position exhibits uniform performance with reduced variability and lower amplitude after the compensation angle is applied (Comp_On) than before the compensation angle is applied (Comp_Off).

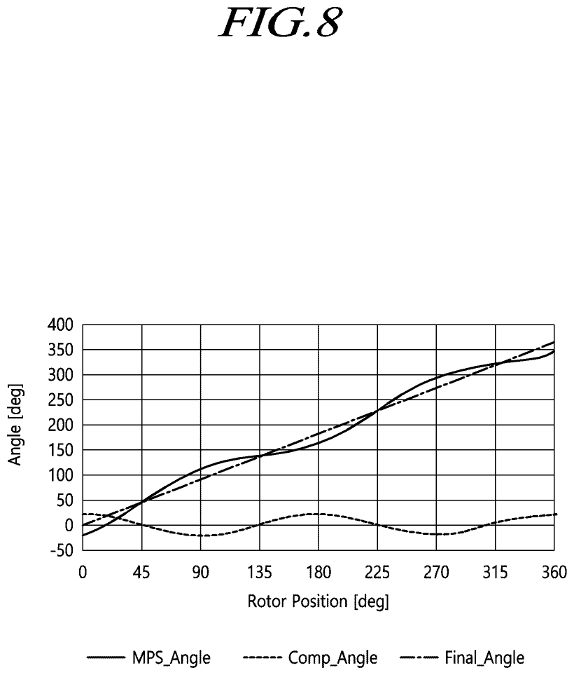

FIG. 8 is a diagram illustrating the result of applying the compensation angle to the second motor position according to one embodiment.

Referring to FIG. 8, the one or more processors 130 may determine a final angle (Final_Angle) to be used for control by adding a compensation angle (Comp_Angle) to a second motor position (MPS_Angle) detected by the MPS. According to the above, the motor position sensor error compensation apparatus 10 of the present disclosure may secure linearity between the first motor position and the second motor position by applying the compensation angle to the nonlinearity occurring in the MPS.

The one or more processors 130 may set a motor position curve using a spline curve based on the plurality of second motor positions corresponding to the plurality of first motor positions, and determine the compensation angle so that the motor position curve has the first motor position value.

The spline curve is a mathematical method for generating a curve that smoothly connects multiple points, and this spline curve mainly uses multidimensional polynomials to form a curve in each section, and thus, the curve may maintain continuity and smoothness at each point.

The one or more processors 130 may determine the compensation angle (Comp_Angle) for the value between the second motor position and the second motor position added as the reference angle by setting the motor position curve (MPS_Angle) through the spline curve.

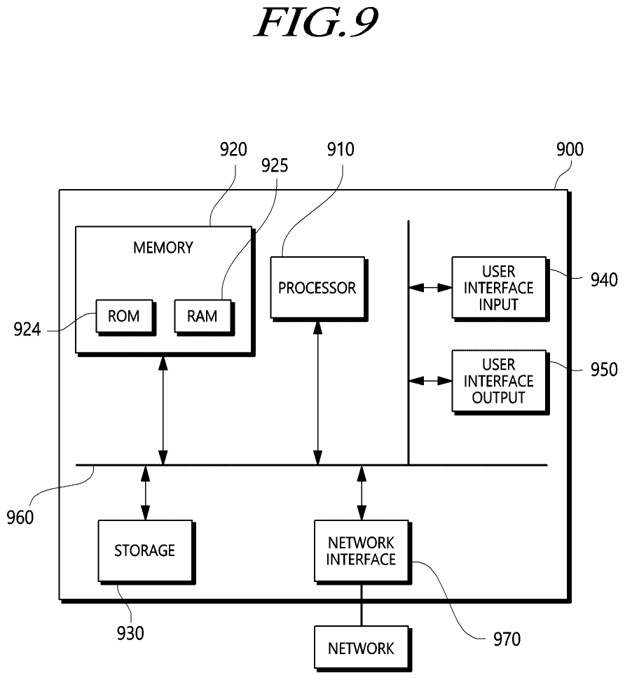

FIG. 9 is a block diagram of the motor position sensor error compensation apparatus 10 according to another embodiment of the present disclosure.

In one embodiment, the motor position sensor error compensation apparatus 10 may be implemented as an electronic control unit (ECU). Referring to FIG. 9, a computer system 900, such as the motor position sensor error compensation apparatus 10, may include at least one or more elements of one or more processors 910, a memory 920, a storage 930, a user interface input 940, and a user interface output 950, which may communicate with each other via a bus 960. In addition, the computer system 900 may also include a network interface 970 for connecting to a network. The processor 910 may be a CPU or a semiconductor device that executes processing instructions stored in the memory 920 and/or the storage 930. The memory 920 and the storage 930 may include various types of volatile/nonvolatile storage media. For example, the memory may include ROM 924 and RAM 925.

Hereinafter, a motor position sensor error compensation method using a motor position sensor error compensation apparatus 10 capable of performing all of the above-described present disclosures will be described.

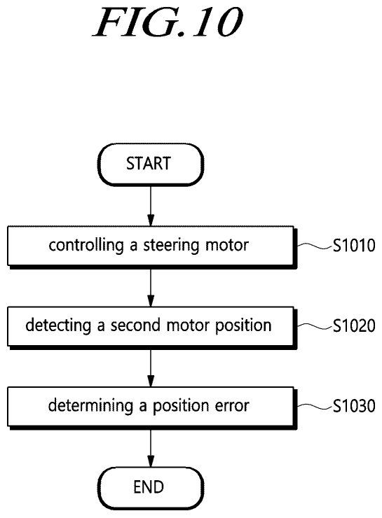

FIG. 10 is a flowchart illustrating a motor position sensor error compensation method according to one embodiment of the present disclosure.

Referring to FIG. 10, the method may include controlling the steering motor to move to the first motor position (S1010), detecting the second motor position of the steering motor through a motor position sensor (S1020), and determining a position error between the controlled first motor position and the detected second motor position and determining a compensation angle for the detected second motor position based on the position error between the controlled first motor position and the detected second motor position (S1030). Here, the motor position may mean the position of the rotor. That is, the rotor, which is one of the components of the steering motor, may be controlled to move to the first motor position.

In the determining of the position error between the controlled first motor position and the detected second motor position comprises obtaining the plurality of calculated position errors between the plurality of calculated first motor positions and the plurality of calculated second motor positions which are calculated by repeatedly adding a reference angle to the controlled first motor position. Accordingly, the S1010 and the S1020 may be repeatedly performed until the first motor position reaches the target point (for example, 360 deg), and as a result, in the S1030, the plurality of position errors may be determined, and the position errors may be stored.

In the determining of the compensation angle comprises generating a compensation table including a plurality of compensation angles according to the plurality of calculated second motor positions, and outputting a compensation angle corresponding to the detected second motor position. Here, the compensation table may include the plurality of first motor positions and the compensation angles corresponding thereto.

In the determining of the compensation angle comprises determining the compensation angle for the detected second motor position by using interpolation when the compensation angle corresponding to the detected second motor position is not included in the compensation table. For example, the compensation angle of the second motor position, where no compensation angle exists, may be determined by using the linear interpolation technique.

In the determining of the compensation angle comprises in the compensation step, setting a motor position curve is set using a spline curve based on the plurality of calculated second motor positions corresponding to the plurality of calculated first motor positions, and determining a the compensation angle for the detected second motor position using is determined so that the motor position curve.

In the determining of the compensation angle comprises determining the compensation angle for the detected second motor position based on an average value of the plurality of position errors.

In the determining of the compensation angle comprises performing Fast Fourier Transform (FFT) on the determined position error between the controlled first motor position and the detected second motor position and adding a result of the performing of the FFT to the determined compensation angle. In addition, the compensation angle may determine the signal opposite to the determined error angle as the compensation angle. For example, in a case where the size of 0.71 and the phase of 271 deg are determined as the FFT result of the position error, the size of the compensation angle may be determined as 0.71 and the phase as 91 deg.

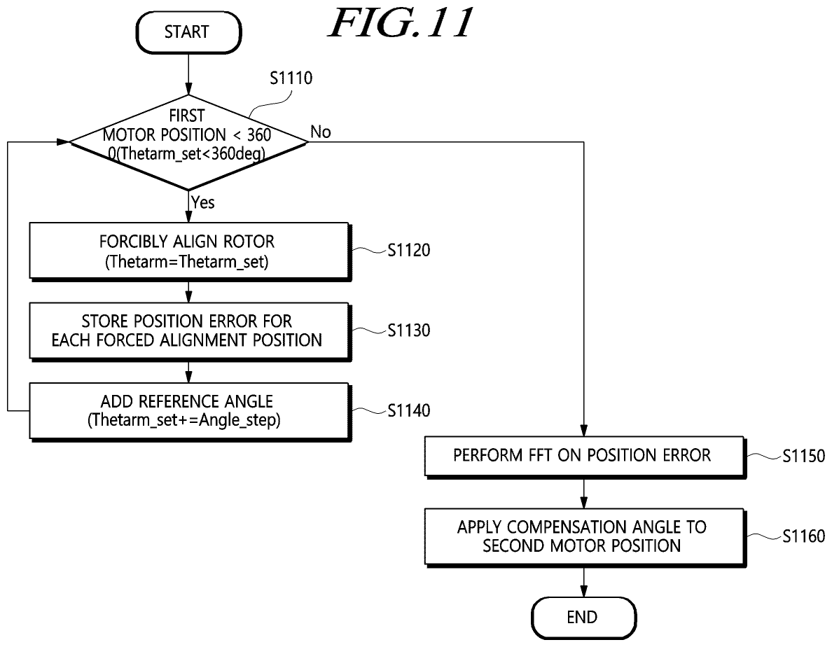

FIG. 11 is a diagram to more specifically explain Step S1030 according to one embodiment.

Referring to FIG. 11, the motor position sensor error compensation apparatus 10 may determine whether the first motor position is less than 360 deg (S1110). Here, the target point 360 deg of the first motor position is an example, and thus, a different angle may be set.

When the first motor position is less than 360 deg (Yes in S1110), the motor position sensor error compensation apparatus 10 may forcibly align the rotor to the first motor position (S1120). Accordingly, the motor position sensor error compensation apparatus 10 may obtain the first motor position, which is the actual position of the steering motor, and the second motor position detected by the MPS.

The motor position sensor error compensation apparatus 10 may store the position error for each forced alignment position (S1130). The motor position sensor error compensation apparatus 10 may determine the position error between the first motor position and the second motor position and store the result.

The motor position sensor error compensation apparatus 10 may add the reference angle to the first motor position (S1140). The reference angle may be set to 1 deg, for example.

When the first motor position is 360 deg or more (No of S1110), the motor position sensor error compensation apparatus 10 may perform FFT on the plurality of position errors and determine the FFT result as the compensation angle (S1150).

The motor position sensor error compensation apparatus 10 may compensate the compensation angle to the second motor position (S1160).

As described above, according to the present disclosure, the motor position sensor error compensation apparatus and method may compensate for the mounting error of the MPS without using a separate test/verification device.

In addition, the present disclosure may reduce the noise and vibration of the secondary component of the MPS machine by compensating for the error of the MPS and reducing the secondary torque ripple of the MPS machine.

Meanwhile, the object recognition device and/or object recognition method according to the present disclosure may be implemented by a vehicle control device.

For example, the vehicle control device may include at least one memory including computer program instructions and at least one processor executing the computer program instructions. The vehicle control device may be an electronic control device including semiconductor devices, such as an ECU or an MCU.

Here, at least one processor may control the steering motor to move to the first motor position, detect the second motor position of the steering motor through a motor position sensor (MPS), determine the position error between the first motor position and the second motor position, and determine the compensation angle for the second motor position based on the position error.

Additionally, at least one processor may add the reference angle to the first motor position in a case of determining the position error, and may obtain the plurality of position errors between the plurality of first motor positions and the plurality of second motor positions.

Additionally, at least one processor may generate the compensation table including the compensation angle according to the second motor position, and output the compensation angle corresponding to the input second motor position.

Additionally, at least one processor may determine the compensation angle by utilizing the interpolation technique in a case where the compensation angle corresponding to the second motor position is not in the compensation table.

Additionally, at least one processor may set the motor position curve using the spline curve based on the plurality of second motor positions corresponding to the plurality of first motor positions, and determine the compensation angle such that the motor position curve has the first motor position value.

Additionally, at least one processor may perform Fast Fourier Transform (FFT) on the position error and add the result of the FFT performance to the compensation angle.

Additionally, at least one processor may determine the compensation angle based on the average value of the plurality of position errors.

The aforementioned vehicle control device or motor position sensor error compensation apparatus may be implemented by a computing system.

That is, the computing system includes at least one processor to execute computer-readable instructions contained in a memory, and at least one processor is capable of performing an operation for compensating for an error of a motor position sensor.

The operation may be an operation of the vehicle control device described above or an operation of a motor position sensor error compensation apparatus and method.

In addition, the computing system may further include ROM, storage devices, or the like, and may transmit and receive information with the processor and external displays and input devices through a bus.

The aforementioned memory may be interpreted to mean main memory, ROM, and storage devices. The computing system may be configured in a vehicle or may be configured as an external device such as a server.

The computer system or computing device can include or be used to implement the system or its components such as the data processing system. The computing system includes a bus or other communication component for communicating information and a processor or processing circuit coupled to the bus for processing information. The computing system can also include one or more processors or processing circuits coupled to the bus for processing information. The computing system also includes main memory, such as a random access memory (RAM) or other dynamic storage device, coupled to the bus for storing information, and instructions to be executed by the processor. The main memory can be or include the data repository. The main memory can also be used for storing position information, temporary variables, or other intermediate information during execution of instructions by the processor. The computing system may further include a read-only memory (ROM) or other static storage device coupled to the bus for storing static information and instructions for the processor. A storage device, such as a solid state device, magnetic disk or optical disk, can be coupled to the bus to persistently store information and instructions. The storage device can include or be part of the data repository.

The computing system may be coupled via the bus to a display, such as a liquid crystal display or active matrix display, for displaying information to a user. An input device, such as a keyboard including alphanumeric and other keys, may be coupled to the bus for communicating information and command selections to the processor. The input device can include a touch screen display. The input device can also include a cursor control, such as a mouse, a trackball, or cursor direction keys, for communicating direction information and command selections to the processor and for controlling cursor movement on the display. The display can be part of the data processing system, the client computing device or other component.

The processes, systems and methods described herein can be implemented by the computing system in response to the processor executing an arrangement of instructions contained in main memory. Such instructions can be read into main memory from another computer-readable medium, such as the storage device. Execution of the arrangement of instructions contained in main memory causes the computing system to perform the illustrative processes described herein. One or more processors in a multiprocessing arrangement may also be employed to execute the instructions contained in main memory. Hard-wired circuitry can be used in place of or in combination with software instructions together with the systems and methods described herein. Systems and methods described herein are not limited to any specific combination of hardware circuitry and software.

Although an example computing system has been described, the subject matter including the operations described in this specification can be implemented in other types of digital electronic circuitry, or in computer software, firmware, or hardware, including the structures disclosed in this specification and their structural equivalents, or in combinations of one or more of them.

The terms “data processing system,” “computing device,” “component,” or “data processing apparatus” encompass various apparatuses, devices, and machines for processing data, including by way of example a programmable processor, a computer, a system on a chip, or multiple ones, or combinations of the foregoing. The apparatus can include special-purpose logic circuitry, for example, an FPGA (field-programmable gate array) or an ASIC (application-specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The components of system can include or share one or more data processing apparatuses, systems, computing devices, or processors

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (for example, one or more scripts stored in a markup language document), in a single file dedicated to the program in question, or in multiple coordinated files (for example, files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (for example, components of the data processing system) to perform actions by operating on input data and generating output. The processes and logic flows can also be performed by, and apparatuses can also be implemented as, special purpose logic circuitry, for example, an FPGA (field-programmable gate array) or an ASIC (application-specific integrated circuit). Devices suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto optical disks; and CD ROM and DVD-ROM disks. The processor and the memory can be supplemented by, or incorporated in, special purpose logic circuitry.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments illustrated, but is to be accorded with the widest scope consistent with the claims.

What is claimed is:

1. A motor position sensor error compensation apparatus comprising:
a controller configured to control a steering motor to move to a first motor position;
a motor position sensor configured to detect a second motor position of the steering motor; and
one or more processors configured to determine a position error between the controlled first motor position and the detected second motor position and determine a compensation angle for the detected second motor position based on the position error between the controlled first motor position and the detected second motor position.

2. The motor position sensor error compensation apparatus of claim 1, wherein the one or more processors are configured to obtain a plurality of calculated position errors between a plurality of calculated first motor positions and a plurality of calculated second motor positions which are calculated by repeatedly adding a reference angle to the controlled first motor position.

3. The motor position sensor error compensation apparatus of claim 2, wherein the one or more processors are configured to generate a compensation table including a plurality of compensation angles according to the plurality of calculated second motor positions, and output a compensation angle corresponding to the detected second motor position.

4. The motor position sensor error compensation apparatus of claim 3, wherein the one or more processors are configured to determine the compensation angle for the detected second motor position by using interpolation when the compensation angle corresponding to the detected second motor position is not included in the compensation table.

5. The motor position sensor error compensation apparatus of claim 2, wherein the one or more processors are configured to set a motor position curve using a spline curve based on the plurality of calculated second motor positions corresponding to the plurality of calculated first motor positions, and determine the compensation angle for the detected second motor position using the motor position curve.

6. The motor position sensor error compensation apparatus of claim 2, wherein the one or more processors are configured to determine the compensation angle for the detected second motor position based on an average value of the plurality of position errors.

7. The motor position sensor error compensation apparatus of claim 1, wherein the one or more processors are configured to perform Fast Fourier Transform (FFT) on the determined position error between the controlled first motor position and the detected second motor position and add a result of the performing of the FFT to the determined compensation angle.

8. A motor position sensor error compensation method comprising:
controlling a steering motor to move to a first motor position;
detecting a second motor position of the steering motor through a motor position sensor; and
determining a position error between the controlled first motor position and the detected second motor position and determining a compensation angle for the detected second motor position based on the position error between the controlled first motor position and the detected second motor position.

9. The motor position sensor error compensation method of claim 8, wherein the determining of the position error between the controlled first motor position and the detected second motor position comprises obtaining a plurality of calculated position errors between a plurality of calculated first motor positions and a plurality of calculated second motor positions which are calculated by repeatedly adding a reference angle to the controlled first motor position.

10. The motor position sensor error compensation method of claim 9, wherein the determining of the compensation angle comprises generating a compensation table including a plurality of compensation angles according to the plurality of calculated second motor positions, and outputting a compensation angle corresponding to the detected second motor position.

11. The motor position sensor error compensation method of claim 10, wherein the determining of the compensation angle comprises determining the compensation angle for the detected second motor position by using interpolation when the compensation angle corresponding to the detected second motor position is not included in the compensation table.

12. The motor position sensor error compensation method of claim 9, wherein the determining of the compensation angle comprises setting a motor position curve using a spline curve based on the plurality of calculated second motor positions corresponding to the plurality of calculated first motor positions, and determining the compensation angle for the detected second motor position using the motor position curve.

13. The motor position sensor error compensation method of claim 9, wherein the determining of the compensation angle comprises determining the compensation angle for the detected second motor position based on an average value of the plurality of position errors.

14. The motor position sensor error compensation method of claim 8, wherein the determining of the compensation angle comprises performing Fast Fourier Transform (FFT) on the determined position error between the controlled first motor position and the detected second motor position and adding a result of the performing of the FFT to the determined compensation angle.

15. A vehicle control device comprising:
memory configured to store instructions; and
at least one processor configured to be operable to execute the instructions to:
control a steering motor to move to a first motor position, detect a second motor position of the steering motor through a motor position sensor, determine a position error between the controlled first motor position and the detected second motor position, and determine a compensation angle for the detected second motor position based on the position error between the controlled first motor position and the detected second motor position.

16. The vehicle control device of claim 15, wherein the one or more processors are configured to obtain a plurality of calculated position errors between a plurality of calculated first motor positions and a plurality of calculated second motor positions which are calculated by repeatedly adding a reference angle to the controlled first motor position.

17. The vehicle control device of claim 16, wherein the one or more processors are configured to generate a compensation table including a plurality of compensation angles according to the plurality of calculated second motor positions, and output a compensation angle corresponding to the detected second motor position.

18. The vehicle control device of claim 17, wherein the one or more processors are configured to determine the compensation angle for the detected second motor position by using interpolation when the compensation angle corresponding to the detected second motor position is not included in the compensation table.

19. The vehicle control device of claim 16, wherein the one or more processors are configured to set a motor position curve using a spline curve based on the plurality of calculated second motor positions corresponding to the plurality of calculated first motor positions, and determine the compensation angle for the detected second motor position using the motor position curve.

20. The vehicle control device of claim 15, wherein the one or more processors are configured to perform Fast Fourier Transform (FET) on the determined position error between the controlled first motor position and the detected second motor position and add a result of performing the FFT to the determined compensation angle.
